(19) United States
(12) Patent Application Publication
(10) Pub. No.: US 2010/0147115 A1
(43) Pub. Date: Jun. 17, 2010

(54) Unidirectional Ratchet Wrench

(76) Inventor: Li-Ju Lee, Taichung (TW)

Correspondence Address: LAW OFFICES OF KHALILIAN SIRA, LLC, 9100 PERSIMMON TREE ROAD, POTOMAC, MD, 20854, US

(21) Appl. No.: 12/332,428

(22) Filed: Dec. 11, 2008

(51) Int. Cl. B25B 13/46

(52) U.S. Cl. 81/60

(57) ABSTRACT

A unidirectional ratchet wrench has a head and a ratcheting assembly. The head has a stationary jaw and a ratchet jaw. The stationary jaw is formed on and protrudes from the head and has an undulating surface. The ratchet jaw is formed on and protrudes from the head and has an arced slot formed in an inner surface of the ratchet jaw. The ratcheting assembly has an engaging tab being movably mounted in the arced slot and selectively engaging and disengaging a bolt head with the inner surface of the stationary jaw when the wrench is respectively rotated in drive and non-drive directions.

### BACKGROUND OF THE INVENTION

1. Field of the Invention

The present invention relates to a wrench, especially to a unidirectional ratchet wrench.

2. Description of the Prior Arts

With reference to FIG. 7, a conventional unidirectional ratchet wrench is used to drive a bolt and comprises a handle, a head (40) and a ratchet assembly.

The head (40) is formed on the handle and has two edges, a stationary jaw (42), a ratchet jaw (43) and a cavity (41).

The stationary jaw (42) is formed on and protrudes from one edge of the head (40) and has an inner surface.

The ratchet jaw (43) is formed on and protrudes from the other edge of the head (40) and has an inner surface, a slot (431), two recesses (432) and two sides. The slot (431) is defined in the inner surface of the ratchet jaw (43) and has an inner end. The recesses (432) are defined in the sides of the ratchet jaw (43) and communicate with the slot (431).

The cavity (41) is formed between the jaws (42, 43) and has a peripheral surface and multiple recesses. The multiple recesses are formed in the peripheral surface of the cavity (41) at intervals to provide a ratcheting space when the head (40) is rotated around a bolt head in a non-drive direction.

The ratcheting assembly is mounted in the ratchet jaw (43) and has a tapered coil spring (44), a retractable tab (45) and two cover plates (46).

The tapered coil spring (44) is mounted in the slot (431) and has an outer end.

The retractable tab (45) is moveably mounted in the slot (431) and has an abutting surface. The retractable tab (45) abuts the outer end of the tapered coil spring (44). The abutting surface of the retractable tab (45) projects into the cavity (41).

The two cover plates (46) are respectively mounted in the recesses (432) in the ratchet jaw (43).

The bolt head has multiple flats and multiple corners formed between adjacent flats. When using the conventional unidirectional ratchet wrench, the peripheral surface of the cavity (41) and the abutting surface of the retractable tab (45) engages the flats of the bolt head. In order to tighten the blot, a torque is applied to the blot head by a turning stroke in the drive direction. When the conventional unidirectional ratchet wrench is rotated in the non-drive direction the retractable tab (45) is pressed into the slot (43) by the corners of the bolt head to disengage the tab (45) from the blot head. Thus, the head (40) can be rotated in the non-drive direction to allow the conventional unidirectional ratchet wrench to be rotated within a limited arc without realigning the head (40) of the wrench with the bolt head. Repeated drive and non-drive rotations tightens or loosens the bolt conveniently. The conventional unidirectional ratchet wrench may be turned over to reverse the drive direction.

Although the tapered coil spring (44) allows the slot (431) to be made shallower and smaller than using a normal coil spring, thereby allowing miniaturization of the conventional unidirectional ratchet wrench, the tapered coil spring (44) is significantly more expensive than a normal coil spring. The ratchet jaw (43) must be thick enough to accommodate the tapered coil spring (44) so limiting miniaturization of the conventional wrench and causing structural weakness to the ratchet jaw (44), thereby preventing application of the conventional unidirectional ratchet wrench to small sized bolts.

Further, the inner end of the slot (431) has to be precisely formed so production of the wrench conventional ratchet requires a precise casting process, linear cutting or LASER cutting, which significantly raises manufacturing cost and may even require two cutting processes during production.

Moreover, the retractable tab (45) of the conventional unidirectional ratchet wrench retracts into the slot (431) in a linear movement, so the abutting surface of the retractable tab (45) projects out from the recession (431) and provides only a small area for contacting the bolt head. Such structure may cause unexpected and unsafe slippage during use. Also, due to limited movement the retractable tab (45) cannot be used on slightly rounded, damaged or non-standard sized bolt heads.

Each recess of the ratchet jaw (43) may be provided with two projections (432) to facilitate connection of a corresponding cover plate (46). When attaching the cover plates (46), the projections (432) are melted and welded with the cover plates (46). However, visible welding marks appear on and around the cover plate (46). Furthermore, the cover plates (46) do not reinforce the ratchet jaw (43) and may be removed by accidentally dropping the conventional ratchet.

To overcome the shortcomings, the present invention provides a unidirectional ratchet wrench to mitigate or obviate the aforementioned problems.

### SUMMARY OF THE INVENTION

The main objective of the invention is to provide a unidirectional ratchet wrench overcoming the problems or shortcomings of the conventional unidirectional ratchet wrench.

The unidirectional ratchet wrench in accordance with the present invention has a wrench body and a ratcheting assembly. The wrench body has a head and a curved slot. The head has an inner surface. The curved slot is formed in the inner surface of the head. The ratcheting assembly is slidably mounted in the curved slot for applying a torque to a blot head during a rotation in the forward direction as well as for ratcheting rotation during a non-drive rotation.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a unidirectional ratchet wrench in accordance with the present invention;

FIG. 2 is an enlarged exploded perspective view of the unidirectional ratchet wrench in FIG. 1;

FIG. 3A is an operational top view in partial section of the unidirectional ratchet wrench in FIG. 1, showing a head of the wrench being aligned with a bolt;

FIG. 3B is an enlarged view of a blunt end of an engaging tab of the ratchet wrench in FIG. 1;

FIG. 4 is an operational top view in partial section of the unidirectional ratchet wrench in FIG. 3A, showing an engaging tab abutting the bolt head;

FIG. 5 is an enlarged top view in partial section of the unidirectional ratchet wrench in FIG. 1, showing the engaging tab engaging the bolt head;

FIG. 6 is an operational top view in partial section of the unidirectional ratchet wrench in FIG. 1, showing the head moving in a non-drive direction; and

FIG. 7 is an exploded perspective view of a conventional unidirectional ratchet wrench in accordance with the prior art.

### DETAILED DESCRIPTION OF TIE PREFERRED EMBODIMENTS

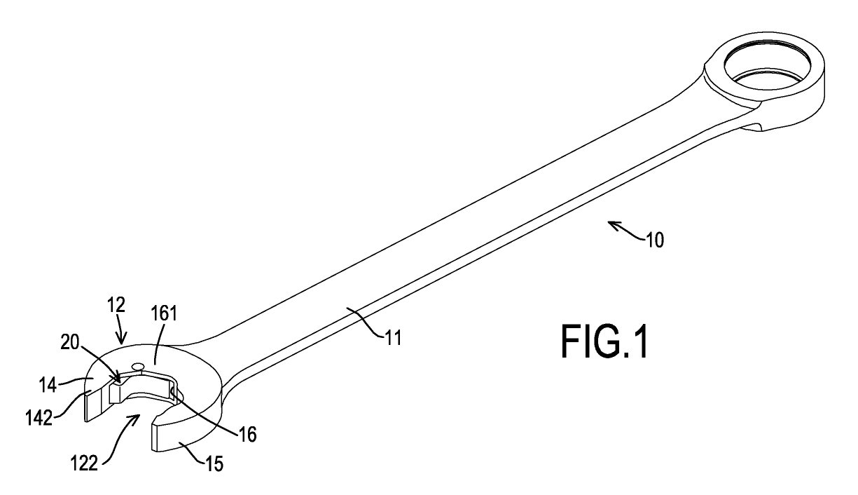

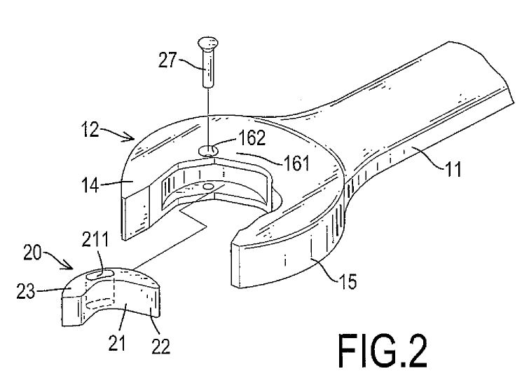

With reference to FIGS. 1 and 2, a unidirectional ratchet wrench in accordance with the present invention comprises a wrench body (10) and a ratcheting assembly (20).

The wrench body (10) has a handle (11) and a head (12).

The head (12) is formed on and protrudes from the handle (11) and has two edges, a stationary jaw (15) and a ratchet jaw (14).

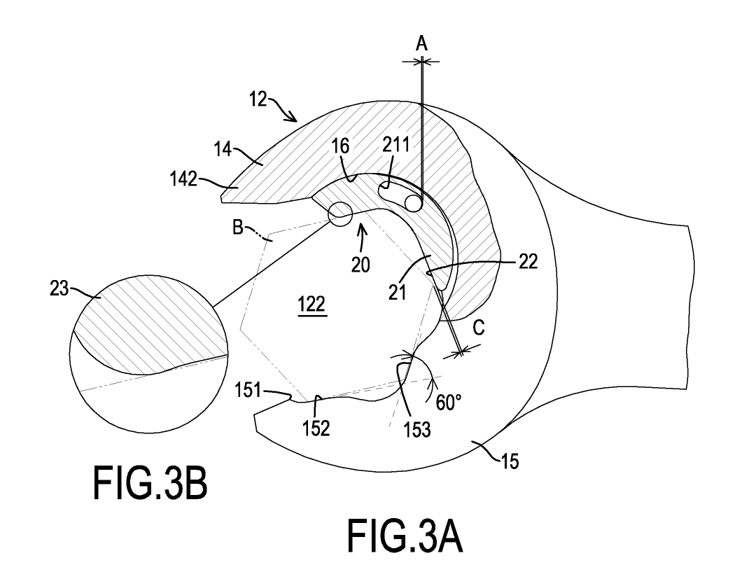

With further reference to FIGS. 3A and 3B, the stationary jaw (15) is formed on and protrudes from one edge of the head (12) and has an undulating surface. The undulating surface may have a distal end, a limiting protrusion (151), a supporting surface (153) and an engaging surface (152). The limiting protrusion (151) is formed on and protrudes from the undulating surface of the stationary jaw (15) adjacent to the distal end of the undulating surface. The supporting surface (153) is formed on the undulating surface. The engaging surface (152) is formed on the undulating surface of the stationary jaw (15) between the limiting protrusion (151) and the supporting surface (153) and has an included angle relative to the supporting surface (153). The included angle between the supporting surface (153) and the engaging surface (152) may be 60 degrees.

The ratchet jaw (14) is formed on and protrudes from the other edge of the head (12) and has an inner surface, an arced slot (16), two side surfaces (161), two pinholes (162) and a distal end.

The inner surface of the ratchet jaw (14) may comprise multiple beveled surfaces.

The arced slot (16) is formed in the inner surface of the ratchet jaw (14), and has an inner surface.

The pinholes (162) are respectively formed through the side surfaces of the ratchet jaw (14) and communicate with the arced slot (16).

The ratcheting assembly (20) is mounted in the arced slot (16) and has an engaging tab (21) and a pin (27).

The engaging tab (21) is movably mounted in the arced slot (16), is arced and has an inner surface, an outer surface, a guide hole (211), a tip end (22), and a blunt end (23). The outer surface of the engaging tab (21) abuts and may correspond to the inner surface of the arced slot (16). The guide hole (211) is formed through the engaging tab (21), is curved and has a drive end and a non-drive end. The non-drive end of the guide hole (211) is disposed near the blunt end (23) of the engaging tab (21). The drive end of the guide hole (211) is disposed opposite to the non-drive end of the guide hole (211).

The blunt end (23) of the engaging tab (21) is adjacent to the distal end of the ratchet jaw (14) and may have a rounded corner adjacent to the inner surface of the engaging tab (21).

The pin (27) is mounted movably through the guide hole (211) and securely in the side surfaces of the ratchet jaw (14), may be in the pinholes (162).

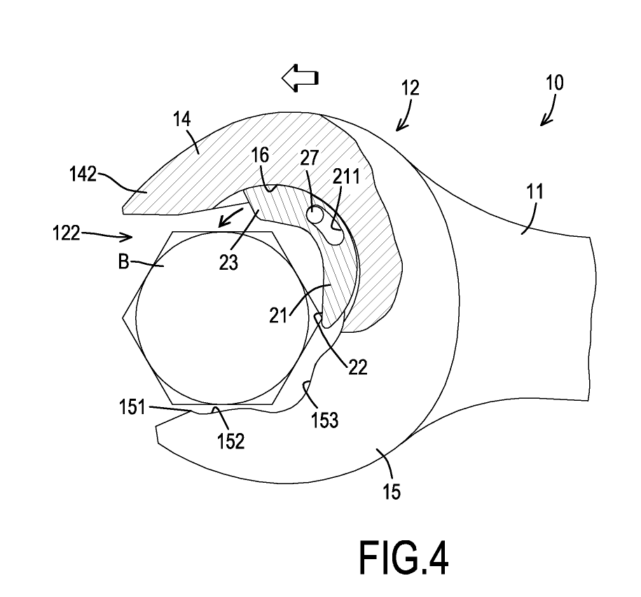

With reference to FIGS. 3 and 4, a ratcheting space (A) is formed between the drive end of the guide hole (211) and the pin (27) to allow the ratcheting assembly (20) to slightly slide in a non-drive direction. When a bolt head (B) having multiple flats and corners disposed between adjacent flats requires tightening or loosening, the head (12) of the unidirectional ratchet wrench as described is mounted around the bolt head (B). A rotating space (C) is formed between the tip end (22) of the engaging tab (21) and one corner of the bolt head (B) allows the ratcheting assembly (20) to slide around the bolt (B). The blunt end (23) of the engaging tab (21) engages the bolt head (B) when the pin (27) abuts the drive end of the guide hole (211).

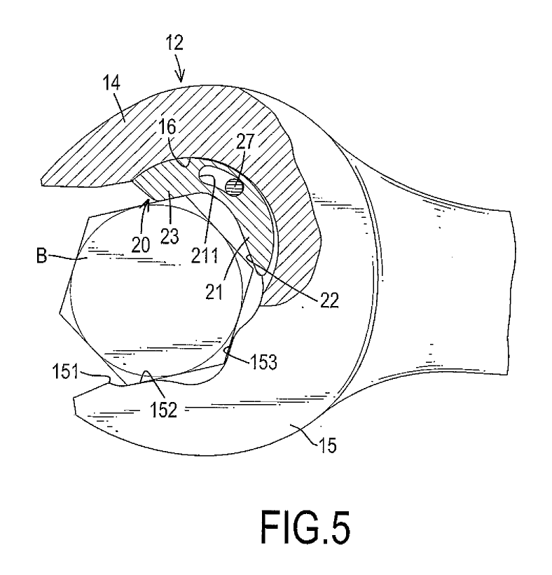

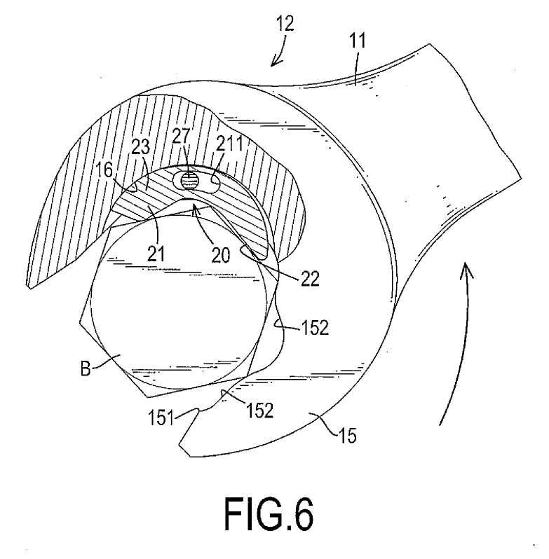

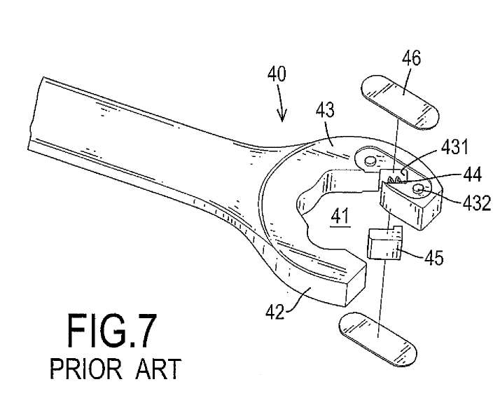

With further reference to FIGS. 5 and 6, the flats of the bolt head (B) abuts the engaging surface (152) and the supporting surface (153) of the stationary jaw (15). Therefore, the handle (11) is rotated in a drive direction to turn the bolt head (B). When the handle (11) is rotated in a non-drive direction, the engaging tab (21) slides along the pin (27), the bolt head (B) rotates relative to the head (12) of the wrench through the recess (152) of the stationary jaw (15) until the handle (11) is rotated in a drive direction causing the engaging tab (21) to re-engage the bolt head (B).

Therefore, the unidirectional ratchet wrench in accordance with the present invention does not require a tapered coil spring so is cheaper to produce. Further, the arced slot (16) is not formed through the sides of the ratchet jaw (14) so does not weaken the ratchet jaw as much as forming a slot through the sides of the ratchet draw. The previous consideration also allows further miniaturization of the unidirectional ratchet wrench as described for implementation with smaller bolt heads, thereby forming new markets.

Moreover, when the unidirectional ratchet wrench as described is used for a bolt in different size, the ratcheting assembly (20) will slide by the arced slot (16) to adjust the best position for the bolt, so the unidirectional ratchet wrench as described is applicable for bolts slightly different in sizes.

Finally, the unidirectional ratchet wrench in accordance with the present invention has a piece with an arced slot (16) and does not need to weld any support to strengthen the piece. The structural strength of the unidirectional ratchet wrench as described is enough for bearing a shock.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A unidirectional ratchet wrench comprising:
a wrench body comprising
a handle; and
a head being formed on and protruding from the handle and having
two edges;
a stationary jaw being formed on and protruding from one edge of the head and having an undulating surface; and
a ratchet jaw being formed on and protruding from other edge of the head to form a space between the ratchet jaw and the stationary jaw for holding a tool head and having
a distal end away from the handle;
an inner surface;
two side surfaces; and
an arced slot being formed in the inner surface of the ratchet jaw and having an inner surface being curved and having a curvature; and
a ratcheting assembly being mounted in the arced slot and comprising
an engaging tab being movably mounted in the arced slot, being arced and comprising
an inner surface;
an outer surface abutting the inner surface of the arced slot, being curved and having a curvature different from that of the inner surface of the arced slot in the ratchet jaw to define a gap between the outer surface of the engaging tab and the inner surface of the arced slot;
a tip end away from the distal end of the ratchet jaw and extending out of the arced slot and into the space between the ratchet jaw and the stationary jaw;
a blunt end being adjacent to the distal end of the ratchet jaw and extending out of the arced slot and into the space between the ratchet jaw and the stationary jaw; and
a guide hole being formed through the engaging tab, being curved and having
a drive end; and
a non-drive end being disposed near the blunt end and being disposed opposite to the drive end; and
a pin being mounted movably through the guide hole and securely in the side surfaces of the ratchet jaw,
wherein the stationary jaw further has
a limiting protrusion being formed on and protruding from the undulating surface of the stationary jaw;
a supporting surface being formed on the undulating surface of the stationary jaw; and
an engaging surface being formed on the undulating surface of the stationary jaw between the limiting protrusion and the supporting surface.

2. (canceled)

3. (canceled)

4. (canceled)

5. The unidirectional ratchet wrench as claimed in claim 1, wherein a ratcheting space is formed between the drive end of the guide hole and the pin to allow the ratcheting assembly to slightly slide in a non-drive direction.

6. (canceled)

7. (canceled)

8. (canceled)

9. The unidirectional ratchet wrench as claimed in claim 1, wherein
the ratchet jaw further has two pinholes being respectively formed through the side surfaces of the ratchet jaw and communicating with the arced slot; and
the pin is mounted in the pinholes.

10-12. (canceled)

13. The unidirectional ratchet wrench as claimed in claim 5, wherein
the ratchet jaw further has two pinholes being respectively formed through the side surfaces of the ratchet jaw and communicating with the arced slot; and
the pin is mounted in the pinholes.

14. (canceled)

15. (canceled)

16. (canceled)

17. The unidirectional ratchet wrench as claimed in claim 1, wherein the engaging surface on the stationary jaw has an included angle relative to the supporting surface being 60 degrees.
